(19) United States
(12) Patent Application Publication
(10) Pub. No.: US 2009/0081605 A1
(43) Pub. Date: Mar. 26, 2009

(54) PHOTODYNAMIC THERAPY DEVICE ADAPTED FOR USE WITH SCALER

(75) Inventors: Alexander Montagu Hay, Bothell, WA (US); Marcus Alan Latham, Seattle, WA (US); Thomas Leonardi, York, PA (US)

Correspondence Address: DOBRUSIN & THENNISCH PC, 29 W LAWRENCE ST, SUITE 210, PONTIAC, MI, 48342, US

(73) Assignee: Ondine International, Ltd.

(21) Appl. No.: 12/234,832

(22) Filed: Sep. 22, 2008

Related U.S. Application Data
(60) Provisional application No. 60/974,906, filed on Sep. 25, 2007.

(51) Int. Cl. A61C 19/06

(52) U.S. Cl. 433/29; 29/896.1

(57) ABSTRACT

The present invention provides a scaler light delivery device comprising a light delivery tip and a light delivery assembly comprising a housing member, a light source and an electronic assembly comprising magnetic means, a rectifier and current control means, wherein the light delivery tip is in secured but removable communication with the light delivery assembly; the light source is in electrical communication with the electronic assembly; the device is adapted for insertion into a receiver of a scaler and when the device is in communication with the receiver, the electronic assembly converts magnetic field energy provided by the receiver into electric energy to power the light source thereby allowing the device to deliver light out of the light delivery tip in a desired illumination pattern and at least one predetermined wavelength. The present invention also includes a method of making the device and using it.

### CLAIM OF BENEFIT OF FILING DATE

This application claims the benefit of U.S. Provisional Application Ser. No. 60/974,906 titled: “Photodynamic Therapy Device Adapted For Use With Scaler” filed on Sep. 25, 2007.

### TECHNICAL FIELD

The present invention relates to a medical device for performing photodynamic therapy upon tissue of an organism. More particularly, the invention is a device adapted for use in conjunction with a conventional scaler to deliver light in a desired illumination pattern and wavelength for photodynamic therapy to an area under treatment.

### BACKGROUND OF THE INVENTION

Photodynamic therapy (“PDT”) has been used to treat various maladies and diseases. PDT often involves the use of a photosensitizing agent that is activated by electromagnetic radiation (e.g., light such as laser light). PDT for killing microbes in the oral cavity, also sometime known as photodynamic disinfection (“PDD”), was disclosed by Wilson, et al. in U.S. Pat. No. 5,611,793 and European Patent No. EP 0637976B2. For the purpose of this specification, photodynamic therapy shall mean both PDT and PDD.

Dental scaling is the use of sonic energy to clean patients' gum and teeth. Dental scaling is performed on a patient generally twice a year and on patients with periodontal diseases several times a year, in some cases every three months or more frequently. Dental scaling is often performed with a conventional ultrasonic or sonic scaler (collectively thereinafter referred to as “scaler”. See Position Paper: Sonic and Ultrasonic Scalers in Periodontics, J. Periodontal 2000:1792-1801). A scaler generates sonic energy (e.g., vibrations) in a fluid (e.g., water, saline or the like) that removes subgingival plaque, calculus and biofilm from the gum tissues, roots and teeth. The vibrations cause cavitation exerting high shear forces directly on the fluid, the calculus, and the plaque surrounding or within the gum tissue, resulting in the detachment of such calculus, plaque and associated biofilm from the gum tissues, roots and teeth. The principles of scalers are well described in the patent literature. See U.S. Pat. Nos. 2,990,616; 3,089,790; 3,703,037; 3,990,452; 4,283,174; 4,804,364; and 6,619,957. Scalers are widely used and can be found in most dental offices.

### SUMMARY OF THE INVENTION

The present invention provides a device and a method by which a scaler can be used with little or no modification to conduct photodynamic therapy, thereby bringing the benefits of photodynamic therapy to many users in a more costs, time and space efficient manner.

In one embodiment, the present invention is a scaler light delivery device comprising: a light delivery tip and a light delivery assembly comprising a housing member, a light source and an electronic assembly comprising magnetic means, a rectifier and current control means, wherein (i) the light delivery tip is in secured but removable communication with the light delivery assembly; (ii) the light source is in electrical communication with the electronic assembly; (iii) the device is adapted for insertion into a receiver of a scaler and when the device is in communication with the receiver, the electronic assembly converts magnetic field energy provided by the receiver into electric energy to power the light source thereby allowing the device to deliver light in a desired illumination pattern and at least one predetermined wavelength. The device is useful in photodynamic therapy because the desired illumination pattern and the at least one predetermined wavelength can activate a photosensitizing composition located at a desired treatment area so as to destroy microbes located at the desired treatment area.

In another embodiment, the present invention is a method for performing photodynamic therapy comprising: providing a photosensitizing composition to the desired treatment area; providing light in a desired illumination pattern and in at least one predetermined wavelength to activate the photosensitizing composition as to destroy microbes located at the desired treatment area using the device of the present invention.

In another embodiment, the present invention is a method for making the device of the present invention comprising providing a light delivery tip and a light delivery assembly comprising a housing member, a light source, and an electronic assembly comprising magnetic means, a rectifier and current control means; and attaching the light delivery tip to the light delivery assembly forming a device adapted to be used in conjunction with a scaler to provide light in a desired illumination pattern and in at least one predetermined wavelength.

A better understanding of the invention will be had upon review of the follow detailed description, which is to be read in conjunction with the accompanying drawings.

### BRIEF DESCRIPTION OF THE DRAWINGS

In the drawings, like reference numerals and letters refer to like parts throughout the various views, unless indicated otherwise:

FIG. 1 is a prospective view of a conventional scaler;

FIG. 2 is a prospective view of the receiver of the scaler shown in FIG. 1;

FIG. 3 is a prospective view of a device constructed in accordance with an embodiment of the invention;

FIG. 4 is a side exploded view of the device shown in FIG. 3;

FIG. 5 is a prospective view of the device in FIG. 3 attached to the receiver of the scaler shown in FIGS. 1 and 2;

FIG. 6 is a prospective view of one embodiment of the electronic assembly of the device shown in FIG. 3;

FIG. 7 is a schematic electrical diagram of a device constructed in accordance with an embodiment of the invention used in conjunction with a scaler;

FIG. 8 is a prospective view of a light diffusing tip and a light source of a device constructed in accordance with another embodiment of the invention;

FIG. 9 is a prospective view of a device constructed in accordance with yet another embodiment of the invention;

FIG. 10 is a side exploded view of the device shown in FIG. 9;

FIG. 11 is a side cross-section view of the device shown in FIG. 9;

FIG. 12 is a side view of the device shown in FIG. 9 partially engaged within the receiver shown in FIG. 2 with a partial cross-section view of both the device shown in FIG. 9 and the receiver shown in FIG. 2;

FIG. 13 is a side view of the device shown in FIG. 9 fully engaged within the receiver shown in FIG. 2 with a partial cross-section view of both the device shown in FIG. 9 and the receiver shown in FIG. 2;

FIG. 14 is a prospective view of a device constructed in accordance with another embodiment of the invention;

FIG. 15 is a side exploded view of the device shown in FIG. 14;

FIG. 16 is a side cross-section view of the device shown in FIG. 14;

FIG. 17 is a prospective view of a device constructed in accordance with yet another embodiment of the invention;

FIG. 18 is a prospective view of the light diffusing tip, the first housing portion, and the o-rings of the device shown in FIG. 17; and

FIG. 19 is a prospective view of a device constructed in accordance with another embodiment of the invention.

### DESCRIPTION OF THE PREFERRED EMBODIMENT

The present invention is predicated upon providing a device that can be used with a scaler to perform photodynamic therapy upon tissue of an organism. Generally, it is contemplated that the present invention may be employed to perform photodynamic therapy upon any tissue of any organism alive or dead and/or upon objects such as denture or other prosthetics and should not be limited to performing therapy on any particular tissue, organism or other object unless otherwise specifically recited. The device has been found to be particularly useful, however, for performing photodynamic therapy upon tissue within the oral cavities of humans. The present invention allows photodynamic therapy to be performed during regular dental scaling treatment and other scaling procedures (e.g., root planting, etc.) using an existing scaler thereby saving time, space, and costs.

I. Definitions

The following terms are intended to have the following general meanings as they are used herein.

1. Microbes: any and all disease-related microbes such as virus, fungus, and bacteria including Gram-negative organisms, Gram-positive organisms or the like.

2. Light: light at any wavelengths that can be absorbed by a photosensitizing composition. Such wavelengths include wavelengths selected from the continuous electromagnetic spectrum such as ultraviolet (“UV”), visible, the infrared (near, mid and far), etc. The wavelengths are generally preferably between about 160 nm to 1600 nm, more preferably between 400 nm to 800 nm, most preferably between about 500 nm to 850 nm although the wavelengths may vary depending upon the particular photosensitizing compound used and the light intensity.

3. Photosensitizing composition: a composition comprising at least one suitable art-disclosed photosensitizer. Arianor steel blue, toluidine blue 0, crystal violet, methylene blue and its derivatives, azure blue cert, azure B chloride, azure 2, azure A chloride, azure B tetrafluoroborate, thionin, azure A eosinate, azure B eosinate, azure mix sicc., azure II eosinate, haematoporphyrin HCl, haematoporphyrin ester, aluminium disulphonated phthalocyanine are examples of suitable photosensitizers. Porphyrins, pyrroles, tetrapyrrolic compounds, expanded pyrrolic macrocycles, and their respective derivatives are further examples of suitable photosensitizers. Photofrin® manufactured by QLT PhotoTherapeutics Inc., Vancouver, B.C., Canada is yet another example of a suitable photosensitizer. Other exemplary photosensitizers may be found in U.S. Pat. Nos. 5,611,793 and 6,693,093. U.S. Pat. No. 6,693,093 is hereby incorporated by reference. The photosensitizers mentioned above are examples are not intended to limit the scope of the present invention in any way.

II. Conventional Scaler

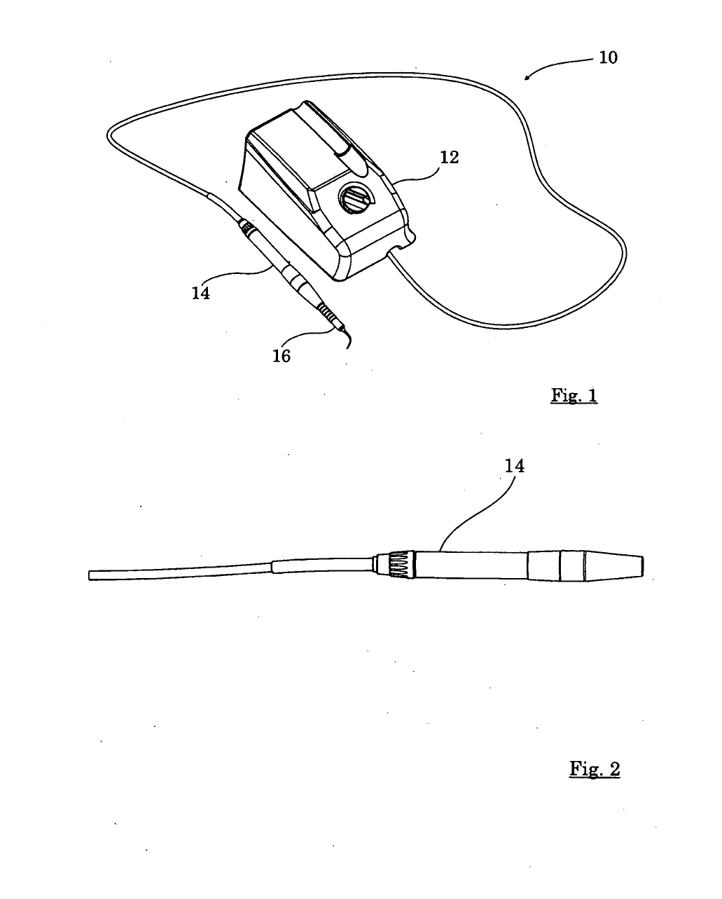

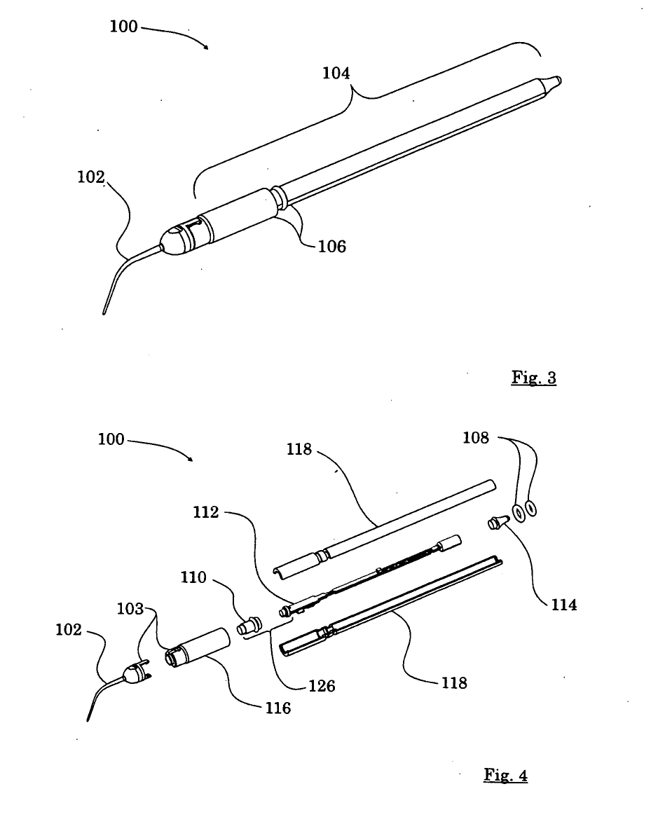

FIG. 1 illustrates a conventional scaler 10 known in prior art comprising a base station 12, a corded receiver 14 (also commonly known as a hand piece), and a scaling insert 16. FIG. 2 illustrates the receiver 14 without the insert 16. The scaling insert 16 shown in FIG. 1 is generally magnetostrictive and adapted to be inserted into the receiver 14 for scaling. The insert 16 is removable from the receiver 14 to allow sterilization of both components. The removability of the insert 16 from the receiver 14 also allows practitioners to switch between inserts 16 with different scaling tip geometries. The receiver 14 includes a sonic or ultrasonic driver mechanism (not shown) such as a magnetic coil or the like (hereinafter referred to as “driver mechanism”), which when coupled with electric energy provided by the base station 12 converts the electric energy into magnetic field energy which is driven into the insert 16 allowing the insert 16 to convert or translate such magnetic field energy into sonic and/or ultrasonic vibrations. The insert 16 delivers such sonic and/or ultrasonic vibrations to the desired treatment area. Generally, the receiver 14 also has an irrigation channel (not shown) connected to a fluid source (not shown) such that when activated by a controller (not shown), fluid (e.g., water, saline, combinations thereof or other fluids) is delivered from the fluid source through the irrigation channel to the desired treatment area.

Prior art reveals that scaling tip inserts that provides both scaling vibrations and light thereby allowing the user to have better visibility of the scaling process. See U.S. Pat. Nos. 6,386,866 and 7,104,794. These prior arts all use simple circuitry (e.g., Zener diode) to provide and control the light delivery. Such light delivery system is generally not desirable for photodynamic therapy because it can either create excess heat or limit the range of light output. For example, it is not desirable to have a laser diode used with such circuitry because a laser diode generally requires better control of current and is susceptible to build up of heat.

III. Apparatus of the Present Invention

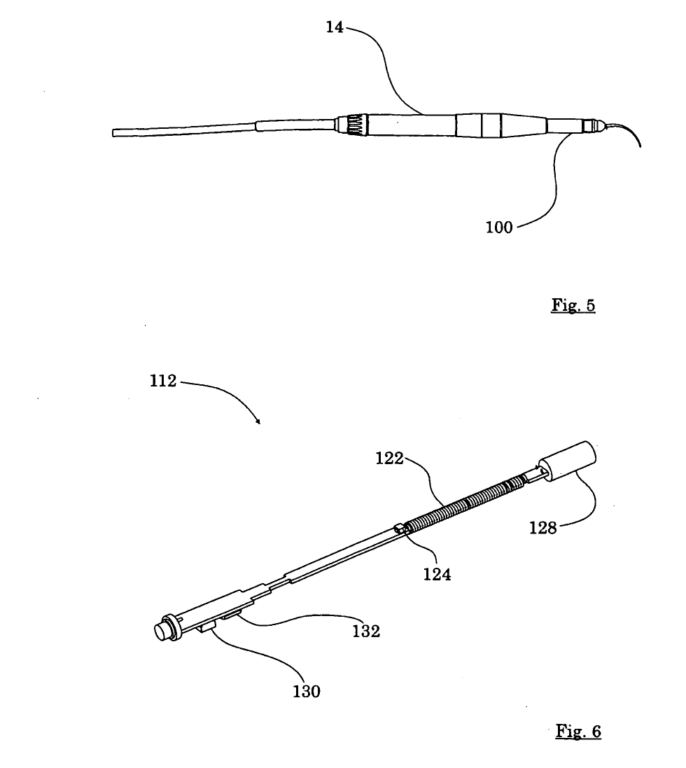

FIGS. 3-4 illustrate an exemplary device 100 of the present invention comprising a light delivery tip, which for the purpose of photodynamic therapy, is a light diffusing tip 102. The device 100 further includes a light delivery assembly 104. The light diffusing tip 102 is adapted for a secure but removable communication with the light delivery assembly 104. The device 100 is adapted for insertion into the receiver 14 of the scaler 10 as shown in FIG. 5 and delivers light in a desired illumination pattern and at least one predetermined wavelength to a desired treatment area for photodynamic therapy.

The light diffusing tip 102 is constructed of substantially transparent material to allow the light to efficiently propagate through its body. The light diffusing tip 102 can be formed from a wide variety of materials. For example, plastic (e.g., acrylic, polycarbonate, polystyrene, or the like), resin (i.e., an epoxy or the like), glass or the like. Using a clear plastic (e.g., polycarbonate, acrylic, or the like) allows the light diffusing tip 102 to be formed by a molding process, resulting in high quality parts with a very low parts cost.

It may be preferred that light delivered to the treatment area from the light diffusing tip 102 has low light loss and an optimal distribution pattern without any especially bright or dim spots.

Referring to FIG. 4, the light diffusing tip 102 has retention means 103 that is adapted for a secured but removable communication with the light delivery assembly 104. The retention means 103 can be any suitable art-disclosed retention means such as the retention tang feature shown in FIG. 4, threads, o-rings, interference fit, adhesive, or the like.

A wide variety of body dimensions for the light diffusing tip 102 can be utilized depending upon the desired application(s) and the treatment area(s) and the accessibility (e.g., opening or the like) to such treatment area(s). A skilled person in the arts would have to take into account the material choice to make the tradeoff between length of the light diffusing tip's body and the amount of taper provided to ensure that the final light diffusing tip 102 design has the required rigidity and strength. Once a mechanical form that fits the application treatment is determined, there remains the issue of ensuring the light is emitted in an appropriate manner.

Surface finish of the light diffusing tip 102 can also contribute to the light distribution and pattern. For example, in one embodiment of the light diffusing tip 102, its taper section has a random rough surface finish (e.g., about 30 um rough surface features) that fills about 25% of the clear area of the surface of the light diffusing tip 102. This surface finish causes about 25% of the light rays encountering a rough patch on the surface of the light diffusing tip 102 are scattered out of its body regardless of their incident angle. In this fashion, the surface finish helps ensure that all the light leaks out of the light diffusing tip 102 in a uniform manner.

In addition to random rough surfaces, surface modification features can be utilized to couple out light and still be within the scope of this invention. Without limitation, these include concave and convex dimples, concave and convex prismatic facets and annular features. There are other techniques that could be used to modify the light emission pattern from the device 100 that would still be in the scope of this invention. For instance, another way to get a uniform output would be to include a material in the bulk of the light diffusing tip's 102 body material that causes internal scattering as the light propagates towards the distal end of the light diffusing tip 102. Without limitation, this material could be a pigment type material such as Titanium Dioxide or material with a different refractive index, such as glass micro spheres or even hollow plastic micro spheres.

Referring to FIGS. 3-4, the device 100 further includes a light delivery assembly 104 comprising a housing 106 and an electronic assembly 112. The housing 106 includes retention means 103 that provides secured but removable communications with the light diffusing tip 102. As shown in FIG. 4, the light delivery assembly 104 may optionally include at least one o-ring 108 (two o-rings are shown in FIG. 4) and/or a stopper 114. The device of 100 also includes a light source 126 that is in electric communication with the electronic assembly 112. The light source 126 may optionally include light coupling means (not shown) that is an art-disclosed optional component generally used to couple light from the light source 126 into the light diffusing tip 102 (e.g., lens, ball lens, mirror, glass or plastic rods, or the like) and a heat sink. For the purpose of identification only, the heat sink 110 is shown separately from the remaining components of the light source 126 (e.g., laser diode, LEDs, etc.) in FIG. 4.

In one embodiment of the present invention as shown in FIGS. 3-4, the light delivery assembly 104 is designed and constructed to be water-proofed in order to prevent contaminants (e.g., liquid, dust, or the like) (i) from entering the housing 106 and/or (ii) from potentially damaging the light source 126, the electronic assembly 112, and any other internal components located within the housing 106. For example, once all of the components of the light delivery assembly 104 have been assembled, including but are not limited to the light source 126, the electronic assembly 112, the at least one o-ring 108, the stopper 114, the housing 106, then the housing 106 can be sealed using art-disclosed techniques (e.g., with ultrasonic welding or the like) to provide a sterile environment for the internal components located within the housing 106.

As shown in FIG. 4, the housing 106 is optionally comprised a first housing portion 116 and a second housing portion 118. The first housing portion 116 provides desired exterior surfaces for an operator to hold and/or grip onto the device 100. In one embodiment, the second housing portion 118 is adapted to fit partially within the first housing portion 116. The first housing portion 116 includes the retention means 103 and can optionally house at least a portion of the heat sink 110. The second housing portion 118 houses the electronic assembly 112 and may optionally house a portion of the stopper 114 and/or the at least one o-ring 108.

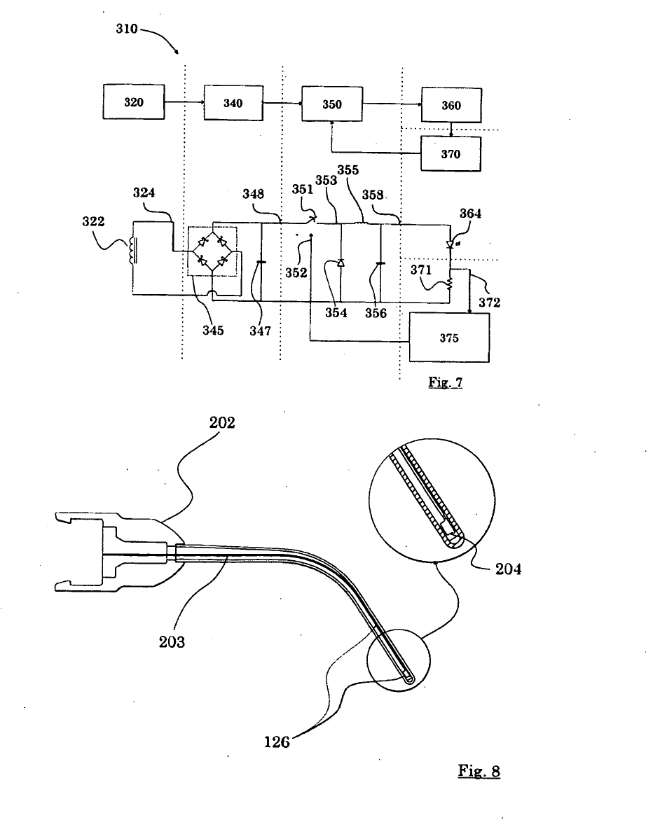

Referring to FIG. 6, the electronic assembly 112 includes magnetic means 122 (shown in FIG. 6 as a magnetic coil), a rectifier 124 and current control means 130. When the device 100 is in communication with the receiver 14, the electronic assembly 112 interacts with the receiver's 14 driver mechanism (not shown in FIG. 6) and converts magnetic field energy provided by the receiver 14 into electric energy desired to power the light source 126. The electronic assembly 112 may optionally include a capacitor 128 and a feedback system 132. The current control means 130 can be any suitable art-disclosed current controller designed to adjust DC voltage to a desired level resulting in a controlled DC voltage output. For example, a DC-DC converter can be used as the current control means 130 especially if the light source 126 is a laser diode.

The schematic electrical diagram depicted in FIG. 7 demonstrates the electrical pathway 310 of one embodiment of the device 100 when used with a scaler. In this embodiment, the electrical pathway 310 has the following stages: inductive pick up stage 320, rectifier stage 340, current control stage 350, the light source stage 360 and an optional feedback system stage 370.

The electrical pathway 310 begins with the inductive pickup stage 320. During this stage, the alternating magnetic field energy generated by the driver mechanism of the receiver 14 is converted by the magnetic means 322 (shown as 122 shown in FIG. 6) into AC (alternating current) voltage 324. The AC voltage 324 proceeds to the rectifier stage 340. During the rectifier stage 340, the rectifier 345 (shown as 124 in FIG. 6) converts the AC voltage 324 to DC (direct current) voltage 348. In one embodiment, the rectifier 345 is a full-bridge schottky rectifier. An optional output capacitor 347 (shown as 128 in FIG. 6) can be used to further process (e.g., smooth) the DC voltage 348 before it goes to the current control stage 350.

During the current control stage 350, current control means (shown as 130 in FIG. 6) adjusts the DC voltage 348 to the desired level resulting into a controlled DC voltage output 358 that will enter the light source stage 360. In this embodiment, the current control means is a DC-DC converter. The DC-DC converter can be any suitable art-disclosed DC-DC converter such as a Buck Converter, a Boost Converter, a Cuk Converter, or the like. Referring to FIG. 7, an exemplary Buck Converter is shown comprising an electronic switch 351 controlled by a PWM signal 352 which delivers pulsed voltage 353 to an inductor 355. A catch diode 354 allows current in the inductor 355 to continue to flow when the electronic switch 351 is open. A filter capacitor 356 smoothes the DC voltage resulting in the controlled DC voltage output 358.

During the light source stage 360, the DC voltage output 358 powers the light source 364 (shown as 126 in FIG. 6). The light source 364 in this embodiment is a laser diode, but other suitable art-disclosed light source for photodynamic therapy can also be used (e.g., LEDs or the like).

Referring to FIG. 7, an optional feedback system stage 370 is described. During the feedback system stage 370, a feedback system 375 (shown as 132 in FIG. 6) monitors system output and adjusts the PWM signal 352 to maintain desired output from the light source 364. The feedback system 375 uses a current sense resistor 371 to create a current sense signal 372 with voltage proportional to the current through the light source 364. The feedback system 375 can be any suitable art-disclosed microprocessor or analog feedback system. For example, a mixed-signal microcontroller such as the PSOC microcontroller made by Cypress Semiconductor can be used as the feedback system 375. Those skilled in the art of electronic design will recognize that the PWM signal 352 may be replaced with a PPM signal or other variable duty cycle signal without changing the function or intent of the overall circuit.

The feedback system 375 is powered by the DC voltage output 358. In another embodiment, voltage control means is used to provide a separately controlled DC voltage output (distinct from the DC voltage output 358 used to power the light source 364) to power the feedback system 375 which in this embodiment is a microprocessor. The voltage control means can be any suitable art-disclosed voltage controller such as a DC-DC converter (which in this embodiment is not the same DC-DC converter that may serve as the current control means). By using the voltage control means to power the microprocessor, it is possible to place a large capacitor on the supply of the microprocessor and allow it to continue to operate after power from the inductive pickup is no longer available. The microprocessor can then control all timing and power control functions needed for the device 100.

The device 100 as described in FIG. 7 is highly efficient when limiting and/or controlling optical output power which can lower heat generation by the device 100. An electronic feedback loop allows for accurate control of the output. A wider input voltage range is also enabled due to the ability to limit output power without generating significant heat. The device 100 allows the use of high power devices such as laser diodes that is often desirable for photodynamic therapy without generation of damaging excess heat.

An alternative embodiment of the device 100 puts the light source 126 inside the light diffusing tip 202 as shown in FIG. 8. The light source 126 in this embodiment includes a cable 203 in electrical communication with light emitting device such as lasers or LEDs 204. The cable 203 is in electrical communication with the electronic assembly 112 (not shown) of the device 100.

As a practical method of ensuring sterility, it may be desirable and optional to construct the device 100 with materials that can withstand standard sterilization techniques such as autoclaving. Also, it is also possible that the device 100 or at least the light diffusing tip 102 of the device 100 is constructed with low cost materials for single use and disposability. Another alternative is to have only portions of the device 100 that are exposed to biohazardous material autoclavable.

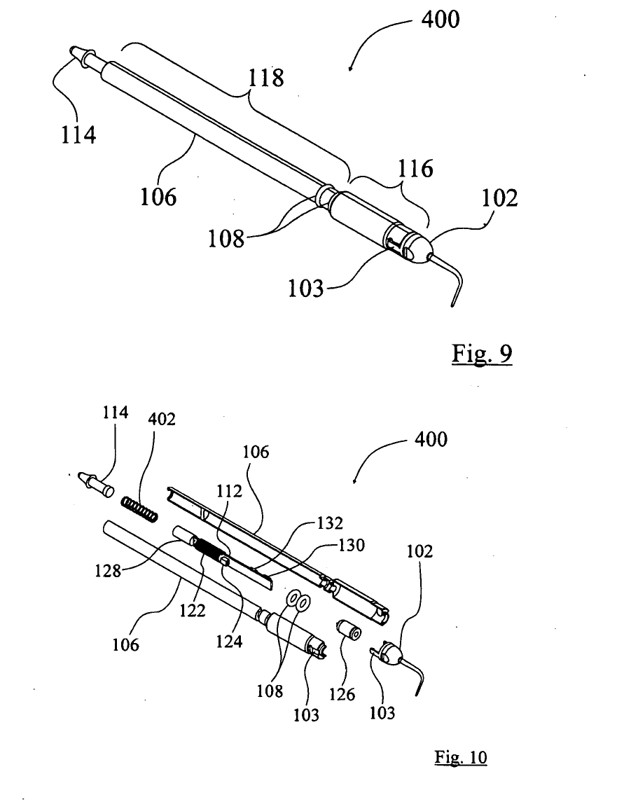

Referring to FIGS. 9-13, another embodiment of the device 400 of the present invention is presented. The device 400 has the same key components as the device 100 such as the light diffusing tip 102, the retention means 103, the light source 126 (which may include optional components such as the light coupling means and the heat sinks discussed above for the device 100), and the light delivery assembly 104 including the housing 106, the at least one o-ring 108, the stopper 114 and the electronic assembly 112. The electronic assembly 112 includes the same key and optional components (i.e., 122, 124, 128, 130, and 132) as described above for the device 100. However, unlike device 100, the at least one o-ring 108 is located between the light source 126 and the electronic assembly 112. The light source 126 is in electric communication with the electronic assembly via a cable 404 as shown in FIG. 11. Also, the stopper 114 of the device 400 is in communication with a spring 402 as shown in FIG. 11. The stopper 114, the spring 402, and the at least one o-ring 108 together act as a retention mechanism to hold the device 400 within the receiver 14 (not shown).

In one embodiment of the device 400, the first housing portion 116 and the second housing portion 118 have a seamless connection between them as shown in FIG. 10. The stopper 114, the spring 402, the at least one o-ring 108, and full and complete sealing of the housing 106 provide sterility. Alternatively, the first housing portion 116 and the second housing portion 118 are two separate components but the light source 126 located within the first housing portion 116 as shown in FIG. 11 is still adapted to be in electrical communication with the electronic assembly 112 located in the second housing portion 118 via the cable 404. It is optional that all components of the device 400 except for the light diffusing tip 102 are made to be reusable and/or autoclavable. The light diffusing tip 102 can optionally be constructed of disposable material.

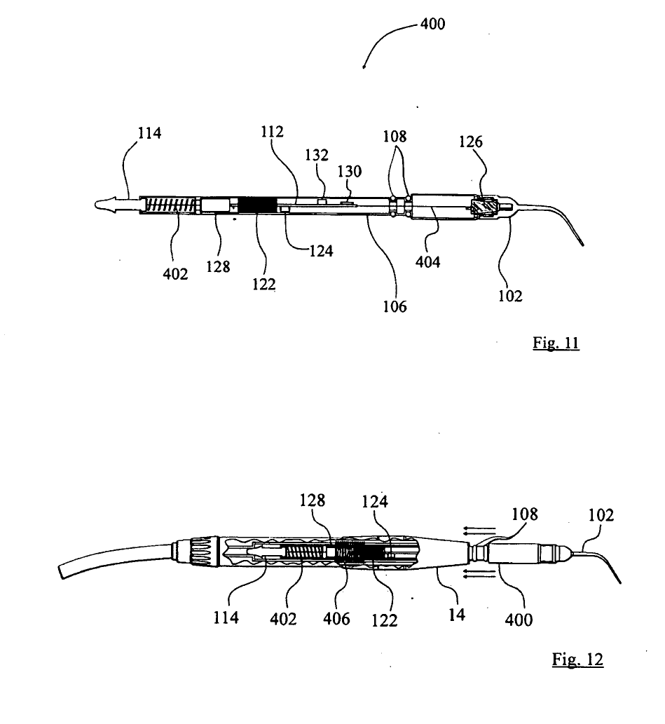

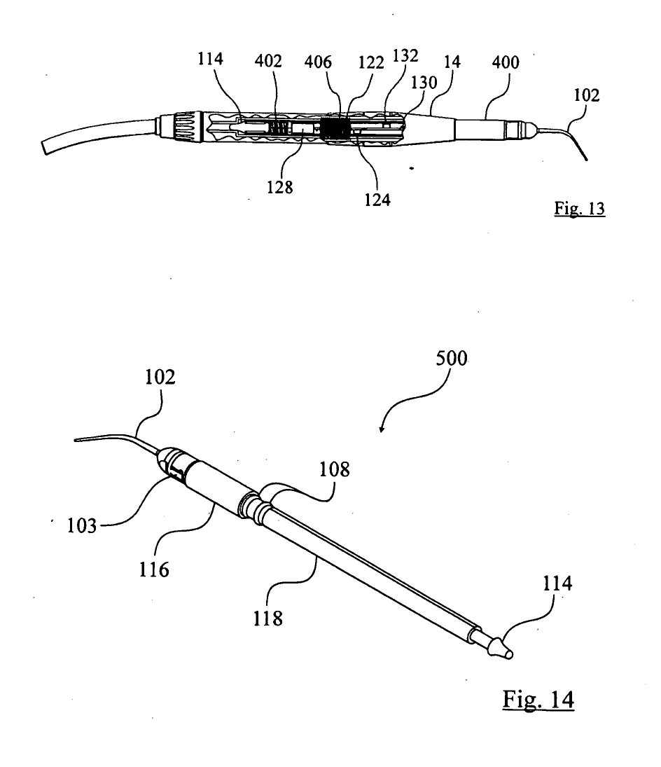

Referring to FIG. 12, when the device 400 is inserted into the receiver 14, the spring 402 in its extended fashion prevents the device 400 from a full and complete engagement with the receiver 14 and thereby preventing the desired interaction (e.g., alignment) between the magnetic means 122 of the electronic assembly 112 and the receiver's 14 sonic or ultrasonic driver mechanism 406 required in order to provide the electric energy needed to power the light source 126. Accordingly, without a full and complete engagement of the device 400 and the receiver 14, the light source will not provide the desired illumination for photodynamic therapy. Referring to FIG. 13, when an operator applies compressive force upon the device 400 to compress the spring 402, a full and complete engagement between the device 400 and the receiver 14 is then achieved providing the desired interaction between the magnetic means 122 and the driver mechanism 406 to power the light source 126 using the same electrical pathway as described above for the device 100. The spring design of the device 400 described in this paragraph shall hereinafter be referred to as “spring safety mechanism”. The spring safety mechanism provides operator safety, because if the light source 126 includes a high power light emitting device (e.g., laser or the like), no light from this light emitting device would come out of the device 400 unless there is a full and complete engagement between the device 400 and the receiver 14. Such a safety feature acts as an interlock service and can substantially reduce the applicable laser safety class and its related requirements for safety features, as listed in the related standard “IEC INTERNATIONAL STANDARD 60825-1, second edition 2007-03 Safety of laser products—Part 1: Equipment classification and requirements.”

Referring to FIGS. 14-16, another embodiment of the device of the present invention 500 is presented. The device 500 includes the following components discussed above for the device 400: the light diffusing tip 102, the retention means 103, the light source 126 (which may include optional components such as the light coupling means and the heat sinks discussed above for the device 100), and the light delivery assembly 104 including the housing 106, the at least one o-ring 108, the electronic assembly 112, the spring 402, and the stopper 114. The electronic assembly 112 includes the same key and optional components (i.e., 122, 124, 128, 130, 132) as described above for both the device 100 and the device 400. The device 500 has and uses the same spring safety mechanism as described above for the device 400. Nevertheless, it is not required that the device 500 uses the same spring safety mechanism as described above for the device 400. For example, in an alternative embodiment, the device 500 does not include the spring 402; instead, the device 500 uses the stopper 114 optionally equipped with the at least one o-ring 108 between the stopper 114 and the receiver 14 similar to the device 100.

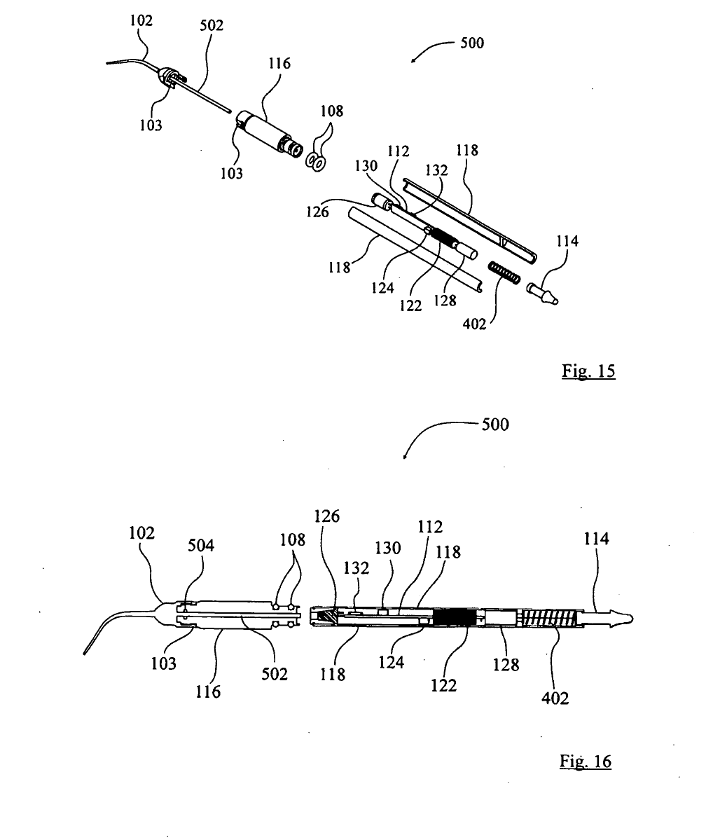

There are some key differences between the device 500 and the device 400. Unlike the device 400, the first housing portion 116 and the second housing portion 118 are separate components as shown in FIGS. 15-16. The at least one o-ring 108 is placed over the first housing portion 116 as shown in FIG. 16. The light diffusing tip 102 of the device 500 includes a waveguide 502 that (i) extends into and is received by the first housing portion 116 and (ii) is adapted to be in light communication with the light source 126 situated in the second housing portion 118. The first housing portion 116 has a through hole adapted to allow the waveguide 502 to go through the first housing portion 116 as shown in FIG. 16 so that the waveguide 502 can have light communication with the light source 126 situated in the second housing portion 118.

When the device 500 are inserted into the receiver 14, the o-rings s assist in keeping the second housing portion 118 and at least a portion of the first housing portion 116 in their proper locations within the receiver 14. When the second housing portion 118 is in its proper location within the receiver 14, the desired interaction between the magnetic means 122 and the driver mechanism 406 is then achieved in order to power the light source 126 using the same electrical pathway as described above for the device 100. Furthermore, the at least one o-ring 108 also provides a barrier for sterility as the light source 126 and the electronics assembly 112 are sealed inside the receiver 14 by the at least one o-ring 108 so that they are not contaminated during photodynamic therapy. Finally, at least one additional o-ring 504 is optionally placed around the waveguide 502 near distal end of the first housing portion 116 to further prevent contamination of the light source 126 and the electronic assembly 112 during photodynamic therapy.

As shown in FIG. 16, the fact that the first housing portion 116 and the second housing portion 118 are separate components with the light source 126 and the electronic assembly 112 housed within the second housing portion 118 offers several advantages. As discussed above, the o-rings (108, 504) provide a sterile environment for components stored within the second housing 118 (e.g., the light source 126 and the electronic assembly 112). Accordingly, the first housing portion 116 and the second housing portion 118 can be constructed of different materials which may reduce costs. For example, the first housing portion 116 can be constructed of either a disposable or autoclavable material while the second housing portion 118 is optionally constructed of non-disposable or autoclavable material.

Moreover, the separate components (116, 118) provide safety. When the light diffusing tip 102 is not attached to the first housing section 116, light from the light source 126 coming out of the device 500 will be limited (if any at all), even if the device 500 is fully engaged with the receiver 14. The light from the light source 126 will mostly terminate upon interior surfaces of the first housing portion 116. To further limit light from the light source coming out of the first housing portion 116 when the light diffusing tip 102 is not attached to the first housing portion 116, the device 500 may optionally have two additional features. First, the first housing portion 116 may optionally have a profile that maximizes absorption/attenuation of light from the light source 126 (e.g., a pocket, notched beam dump, or the like) when the light diffusing tip 102 is not attached to the first housing portion 116. Second, the through hole of the first housing portion 116 may optionally have a surface finish designed to absorb light and to minimize light transmission by reflection should the light diffusing tip 102 is not attached to the first housing portion 116. Without the light diffusing tip 102 attached to the first housing portion 116, the device 500 maintains operator safety by attenuating majority of the light within the first housing portion 116. This safety feature may allow the device 500 using a laser as the light source 126 to be classified as a lower class laser. Lasers are generally classified from Class 1 to Class 4. Such a safety feature can substantially reduce the applicable laser safety class and its related requirements for safety features, as listed in the related standard “IEC INTERNATIONAL STANDARD 60825, second edition 2007-03 Safety of laser products—Part 1: Equipment classification and requirements.”

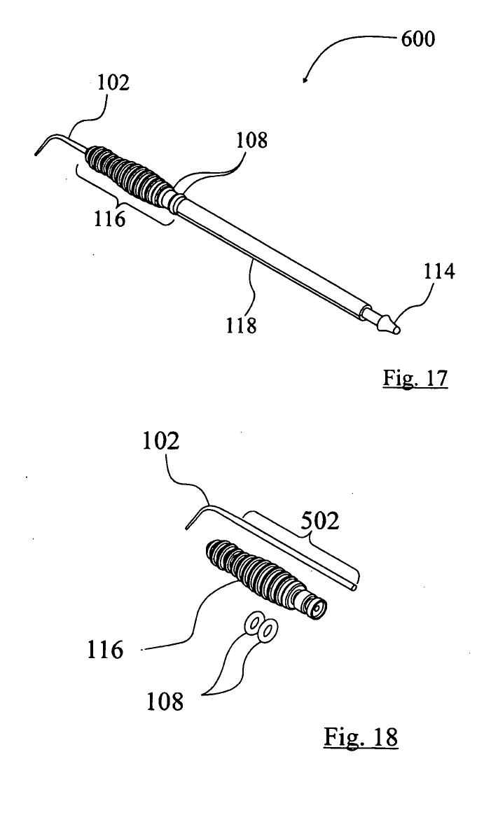

Referring to FIGS. 17-18, another embodiment of the device of the present invention 600 is presented. The device 600 has the same components as described above for the device 500 except that: (i) the retention means 103 of the device 500 is no longer necessary; (ii) the light diffusing tip 102, shown with the waveguide 502 in FIG. 18, bears a different geometry compared to the light diffusing tip 102 of the device 500; (iii) the first housing portion 116 is shaped in a specific ergonomic fashion to facilitate better grip and/or control while the second housing portion 118 and the stopper 114 remain same as the device 500. In one embodiment of the device 600, the first housing portion 116, the light diffusing tip 102 including the waveguide 502, and the at least one o-ring 108 as shown in FIG. 18 are all constructed of disposable material(s).

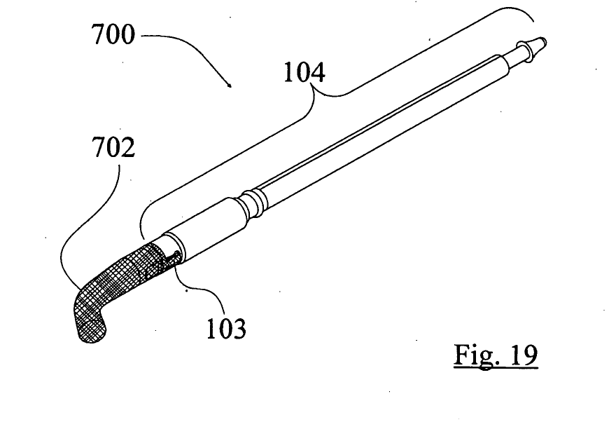

Referring to FIG. 19, another embodiment of the device of the present invention 700 is presented. The device 700 has the same components as described above for the devices 100, 400 and 500 described above except that the light diffusing tip 102 is replaced by a light curing tip 702 attached to the light delivery assembly 104 as shown in FIG. 19. The curing tip 702 can be used for various dental treatments including but not limited to curing epoxies used to fill dental caries, curing cement used for dental veneers and/or crowns, etc.

It is contemplated and within the scope of the present invention that a variety of suitable art-disclosed means can be used to deliver the photosensitizing composition to the desired treatment area. For example, the photosensitizing composition can be delivered using a fluid applicator such as syringe, a pipette, or the like.

This fluid applicator can be designed for single use and packaged in a disposable kit that further includes the device (100, 400, 500, 600) or just the light diffusing tip 102. The disposable kits discussed herein may also include the photosensitizing composition, either stored within the fluid applicator or in a separate container.

It is also contemplated and within the scope of the present invention that the photosensitizing composition be delivered using the irrigation channel of the scaler 10. The photosensitizing composition can be delivered to the irrigation channel using various art-disclosed means such as a manifold can be added to the scaler 10 allowing fluid from multiple sources to be injected into the irrigation channel and a controller (e.g., a hand switch, a foot switch or the like) can be used to activate a pump that draws the photosensitizing composition from a photosensitizing composition source and injects it into the manifold and then to the irrigation channel.

It is also within the scope of this invention if a separate fluid tube outside of the scaler 10 is used to deliver the photosensitizing composition to the treatment area.

IV. Methods of the Present Invention

The present invention provides a method to perform photodynamic therapy comprising: providing a photosensitizing composition to a desired treatment area; providing light in a desired illumination pattern and in at least one predetermined wavelength to activate the photosensitizing composition located at the desired treatment area for killing of microbes located at the desired treatment area using the device (100, 400, 500, 600) of the present invention described above.

The present invention further provides a method for making the device (100. 400, 500, 600) comprising: providing the light diffusing tip 102 and the light delivery assembly comprising the housing 106, the light source 126 and the electronic assembly 112; attaching the light diffusing tip 102 to the light delivery assembly 104.

The above description is intended to be exemplary in nature only. A person skilled in the art would understand that there are different kinds of materials that could be used to make the device (100, 400, 500, 600, 700) described above. Therefore, the foregoing description is not intended to limit what is considered to be the spirit and scope of the invention. The scope of the invention is to be limited only by the claims that follow, the interpretation of which is to be made in accordance with the standard doctrines of patent claim interpretation.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

What is claimed is:

1. A scaler light delivery device comprising:
a light delivery tip and a light delivery assembly comprising a housing member, a light source and an electronic assembly comprising magnetic means, a rectifier and current control means, wherein
the light delivery tip is in secured but removable communication with the light delivery assembly;
the light source is in electrical communication with the electronic assembly;
the device is adapted for insertion into a receiver of a scaler and when the device is in communication with the receiver, the electronic assembly converts magnetic field energy provided by the receiver into electric energy to power the light source thereby allowing the device to deliver light out of the light delivery tip in a desired illumination pattern and at least one predetermined wavelength.

2. The device according to claim 1 wherein the light delivery tip is a light diffusing tip and the light in the desired illumination pattern and the at least one predetermined wavelength can activate a photosensitizing composition located at a desired treatment area so as to destroy microbes located at the desired treatment area.

3. The device according to claim 1 wherein the light delivery assembly further includes a safety spring mechanism comprising at least one o-ring, a spring, and a stopper.

4. The device according to claim 1 wherein the electronic assembly further includes a capacitor.

5. The device according to claim 1 wherein the electronic assembly further includes a feedback system.

6. The device according to claim 5 wherein the feedback system includes a current sense resistor.

7. The device according to claim 1 wherein the electronic assembly converts the magnetic field energy provided by the receiver into the electric energy to power the light source is achieved with an electrical pathway that includes (i) an inductive pickup stage whereby the magnetic field energy is converted by the magnetic means into alternating current voltage; (ii) a rectifier stage whereby the rectifier converts the alternating current voltage into a direct current voltage; (ii) a current control stage whereby the current control means controls the direct current voltage into a desired level; and (iii) a light source stage whereby the desired level of direct current voltage powers the light source.

8. The device according to claim 1 wherein the rectifier is a full-bridge schottky rectifier.

9. The device according to claim 1 wherein the current control means is a DC-DC converter selected from the group consisting of a Buck Converter, a Boost Converter and a Cuk Converter.

10. The device according to claim 1 wherein the light source further includes a heat sink.

11. The device according to claim 1 wherein the light source further includes light coupling means.

12. The device according to claim 11 wherein the light coupling means includes ball lens.

13. The device according to claim 1 wherein at least a portion of the device is autoclavable.

14. The device according to claim 1 wherein the light delivery tip is removably attached to the light delivery assembly via retention means.

15. The device according to claim 1 wherein the light delivery tip is constructed of disposal material.

16. The device according to claim 2 wherein the light source is located within the light diffusing tip and in communication with the electronic assembly located within the housing via a cable.

17. The device according to claim 1 wherein (i) the housing includes a first housing portion and a second housing portion; and (ii) the electronic assembly is located within the second housing portion in a sterile environment.

18. The device according to claim 17 wherein (i) the first housing portion and the second housing portion are two separate components; (ii) the first housing portion has an ergonomic shape; (iii) the light source is located within the second housing portion; (iv) the light delivery tip is a light diffusing tip and the light diffusing tip further includes a waveguide that is in light communication with the light source; and (v) the first housing portion includes a through hole that allows the waveguide to pass through the first housing portion and be in light communication with the light source.

19. The device according to claim 17 wherein the light diffusing tip including the waveguide and the first housing portion are all constructed of disposable material.

20. The device according to claim 1 wherein the light delivery tip is a light curing tip.

21. The device according to claim 1 wherein the electronic assembly is protected within the housing from contaminants.

22. The device according to claim 1 wherein the electronic assembly cannot convert the magnetic field energy provided by the receiver into the electric energy to power the light source unless there is a complete and full engagement between the device and the receiver.

23. The device according to claim 1 wherein design of the housing prevents light from escaping the device when the light delivery tip is not in communication with the light delivery assembly, even if the electronic assembly is converting the magnetic field energy provided by the receiver into the electric energy to power the light source.

24. A method for performing photodynamic therapy comprising:
providing a photosensitizing composition to a desired treatment area;
providing light in a desired illumination pattern and in at least one predetermined wavelength to activate the photosensitizing composition using a light delivery device that is in secured but removable communication with a receiver of a scaler and comprising:
a light diffusing tip and a light delivery assembly comprising a housing member, a light source and an electronic assembly comprising a rectifier and current control means, wherein the light diffusing tip is in secured but removable communication with the light delivery assembly;
the light source is in electrical communication with the electronic assembly; and
the device is adapted for communication with a receiver of a scaler and delivers light in a desired illumination pattern and at least one predetermined wavelength.

25. A method for making a light delivery device adapted to be used in conjunction with a scaler:
providing a light delivery tip that is adapted for secured but removable communication with a light assembly;
providing the light delivery assembly comprising a housing member, a light source and an electronic assembly comprising magnetic means, a rectifier and current control means, wherein the light source is in electrical communication with the electronic assembly; and the device is adapted for communication with a receiver of a scaler and delivers light in a desired illumination pattern and at least one predetermined wavelength.
